(19) United States
(12) Patent Application Publication
(10) Pub. No.: US 2022/0161419 A1
(43) Pub. Date: May 26, 2022

(54) MULTIAXIAL ROBOTIC ARM

(71) Applicant: MacGregor Norway AS, Arendal (NO)

(72) Inventors: Rolf Albrigtsen, Grimstad (NO); Kai Ingvald Flateland, Dølemo (NO); Even Ugland, Kristiansand S (NO); Per-Ove Løvsland, Kristiansand S (NO); Sondre Sanden Tørdal, Grimstad (NO); Eivind Gimming Stensland, Kristiansand S (NO); Arne Sigvald Tomstad, Kristiansand S (NO); Klaus Halvor Hansen, Kragerø (NO)

(73) Assignee: MacGregor Norway AS, Arendal (NO)

(21) Appl. No.: 17/440,635

(22) PCT Filed: Mar. 17, 2020
(86) PCT No.: PCT/EP2020/057302

§ 371 Date: Sep. 17, 2021

(30) Foreign Application Priority Data
Mar. 18, 2019 (NO) 20190365

(51) Int. Cl. B25J 9/06; B25J 9/04; B25J 9/16; B25J 19/02; B63B 27/30

(52) U.S. Cl. CPC B25J 9/06; B25J 9/046; B63B 27/30; B25J 9/1697; B25J 19/021; B25J 9/1666

(57) ABSTRACT

A robotic arm for automatically displacing an object between two locations based on a combination of pre-set instructional data and dynamically updated instructional data includes a robotic arm sensor for detecting objects located within a distance Dᵣₛ from a reference point on the robotic arm and, the robotic arm sensor is configured to determine, based on receiving signals from the detected object, at least one of the distance to the detected object, the size of the detected object, and at least one physical property of the detected object.

### TECHNICAL FIELD

The present invention relates to a multiaxial robotic arm, a vessel comprising such a robotic arm and a method thereof.

### BACKGROUND AND PRIOR ART

Performing operations between a floating vessel and a fixed structure, or between two floating vessels, are normally challenging due to unpredictable movement caused by external forces such as wind, currents, waves, etc. A vessel may move in 6 degrees of freedom, i.e. the rotational motions roll, pitch and yaw and the translation motions heave, sway and surge. If operations are needed between two floating vessels, the 6 degrees of freedom on one vessel will act independently of the 6 degrees of freed on the other vessel.

Several systems are known that allows transfer of objects by aid of a remotely controlled crane from a vessel on which the crane is mounted to another vessel or fixed structure. In all these prior art systems, the motions are based on measurements from motion reference units situated on the respective vessel/structures.

To enable motion compensation, the prior art crane is provided with motion compensating manipulators that are configured to compensate for the motion of the vessel(s) in order to ensure stable and accurate position of relevant tools on the crane.

Examples of prior art solutions using remotely controlled cranes for allowing transfer of objects from a vessel to another vessel/structure may be found disclosed in the following patent publications:

DE 10 2012 219 198 A1 disclosing a method involving depositing cargo on a second vessel utilizing a hoisting device such as a crane arranged on a first vessel. Movements of the two vessels are determined by use of a sensor fixed to the hoisting device and a sensor fixed to the second vessel. A hoisting device controller allows compensation of the position of the load relative to the movement of the second vessel. Translational movements and rotating movements of the second vessel are registered and transmitted using sensors arranged thereon.

GB 2001035 A disclosing a vertical compensating apparatus fastened to a hook of a crane. The apparatus includes a cylinder and piston assembly supporting the load on a second hook fixed to the apparatus and automatically varies the distance between the crane hook and the compensated hook in order to compensate for relative vertical movements of a platform supporting the crane and another platform to or from which the load is to be transferred. Sensors generating a signal in response to vertical movements are associated with each platform.

WO 2018/030897 A1 disclosing a motion compensating crane system mounted on a first vessel having a motion reference unit. The crane system is configured to first transfer and fasten another motion reference unit to a second vessel and then transfer a motion compensated load to the latter vessel based on positioning date from the two motion reference units on respective vessels. In addition, the first vessel is motion compensating using an on-board dynamic position system (DP).

Common for all the prior art solutions are the need for arranging a second motion measurement unit onto which any object is to be transferred.

It is thus an object of the present invention to provide a transfer system that allows transfer of objects with low or no risk of collision with surrounding structure.

More specifically, it is an object of the present invention to provide a transfer system that allows objects to be transferred between locations even when a plurality of predicted and unpredicted obstacles is present within a possible transfer path.

It is also an object of the present invention to provide a transfer system that allows transfer of objects from one locations to another independently of any equipment installed on the location the object is to be transferred.

### SUMMARY OF THE INVENTION

The present invention is set forth and characterized in the main claims, while the dependent claims describe other characteristics of the invention.

In a first aspect, the invention concerns a multiaxial robotic arm suitable for automatically displacing an object such as a mooring line, a container, etc. between two locations based on a combination of pre-set instructional data and dynamically updated instructional data.

The robotic arm comprises a first robotic arm section having a first longitudinal end configured to be rotatably coupled to a support structure via a motorized joint, for example a motorized single axis joint such as a motorized swivel, optionally a second robotic arm section coupled with a non-zero angle such as a 90° angle to the first robotic arm section relative to the longitudinal direction of the first and second robotic arm sections and a third robotic arm section rotationally coupled directly or indirectly to the first robotic arm section, for example directly to the optional second robotic arm section. The rotational axis of the third robotic arm section is preferably parallel to the rotational axis of the first robotic arm section.

The robotic arm further comprises a plurality of robotic arm sections, wherein each of the plurality of robotic arm sections are rotatably coupled via motorized single axis joints with respective single rotational axes and wherein an innermost longitudinal section of the plurality of robotic arm sections is rotatably coupled to the third robotic arm section via a motorized single axis joint with a respective rotational axis.

The rotational couplings within the plurality of robotic arm sections, as well as the rotational coupling to the third robotic arm section, are configured such that the longitudinal direction of the outermost longitudinal section coincides with a rotational axis of the third robotic arm section.

If corrected for any offset along the rotational axis of the sections within the single axis joints, the latter feature may also be reformulated as follows:

The plurality of robotic arm sections forms a common rotational plane within which all rotational movements of the plurality of robotic arm sections are restricted.

The robotic arm also comprises a gripping tool rotatably fixed to a longitudinal end of an outermost longitudinal section of the plurality of robotic arm sections via a motorized multiple axis joint with respective multiple rotational axes.

All single rotational axes of the plurality of robotic arm sections are preferably oriented parallel to each other.

In a preferred example of the robotic arm, the multiple axis joint is configured to allow simultaneous rotation of the gripping tool around a first rotational axis and around a second rotational axis directed perpendicular to the first rotational axis. As a result, the simultaneous rotation of the gripping tool around the first and second rotational axis is restricted to spherical coordinates in space. The rotation around the first and second rotational axis may be achieved by use of two motorized swivels oriented to provide the desired mutual orientation of their rotational axes.

In addition, the gripping tool may be equipped with means to change its length. For example, the gripping tool may comprise a telescopic gripping shaft allowing controlled adjustment of length within a set range.

In another preferred example, the plurality of robotic arm sections further comprises an intermediate section rotationally fixed to the innermost section via a single axis joint with a respective single rotational axis and to the outermost section via a single axis joint with a respective rotational axis.

Including the second robotic arm section, the robotic arm has in this particular example minimum five rotational axes.

Each single axis joint of the plurality of robotic arm sections may comprise a motorized swivel and a single axis control system for controlling rotational speed and direction of the motorized swivel in accordance with received instructional data. Each control system may be arranged adjacent and/or a distance from the rotational part of the respective swivel.

Furthermore, the multiple axis joint of the gripping tool may comprise a plurality of motorized swivels and a multiple axis control system for controlling rotational speed and direction of each motorized swivel in accordance with received instructional data. As for the single axis joints mentioned above, the control system(s) of the multiple axis joint may be arranged adjacent and/or distance from the rotational part of the swivels. Further, there may be one dedicated control system unit for each swivel.

In another preferred example, the robotic arm further comprises a robotic arm sensoring means for detecting, and more preferably imaging, objects located within a distance Dᵣₛ from a reference point on the robotic arm.

The robotic arm sensoring means may for example be arranged on the outermost longitudinal section and/or the gripping tool. However, an arrangement on a section located further way from the outermost section/gripping tool such as on the intermediate section is also feasible.

The reference point may for example be located on the robotic arm sensoring means itself or on an outer extremity of the gripping tool.

The robotic arm sensoring means may further be configured to determine, based on receiving signals from a detected object such as echo signals, the distance to the detected object, the size of the detected object such as the cross sectional area perpendicular to the line of sight of the sensoring means and/or at least one physical property of the detected object such as temperature, colour, radioactivity, chemical substance, etc.

Examples of robotic arm sensoring means may be 2D camera(s), 3D camera(s), radar(s), laser(s), ultrasonic sensor(s), ultraviolet sensor(s) and/or infrared sensor(s). An instrument that is using one or more of the three latter examples is LIDAR which allows surveying of objects by measuring distance to a target through illuminating the target with pulsed laser light and measuring the reflected pulses with a sensor. Differences in laser return times and wavelengths can then be used to make digital 3D representations of the target.

The robotic arm may also comprise a robotic arm positioning means configured to measure one or more positional parameters of a detected object. The positional parameters may for example be a position relative to the reference point on the robotic arm, a velocity relative to a reference point on the robotic arm, a velocity change within a predefined time period such as 1 second, a position change within a predefined time period such as 1 second and/or a directional change within a predefined time period such as 1 second.

Examples of robotic arm positioning means may be earth fixed GPS and/or differential GPS (D-GPS). As mentioned above, a LIDAR may thus also be used as a positioning means in addition to as a sensoring means. In general, the sensoring means and the registration means can constitute a single unit.

The robotic arm may comprise additional global positioning sensors such as earth fixed GPS and/or D-GPS. Furthermore, the robotic arm may comprise additional local positioning sensor such as gyroscopes sensing rotation in three-dimensional space and/or motion reference units being a kind of inertial measurement unit with single- or multi-axis motion sensors.

In another preferred example the robotic arm may comprise a control system having a plurality of modules. One or more of these modules may further comprise at least one pre-processing module configured to receive data generated by at least one sensoring means or at least one positioning means or a combination thereof and to select a data subset of the received data for further data processing and at least one processing module configured to receive the data subset from the at least one pre-processing module. The data subset may further be used as input data in a computer program stored on a computer-readable data carrier, for example in the at least one processing module. The computer program may comprise instructions which, when the program is executed by the at least one processing module and/or by a separate computer, cause the computer program to provide as output instructional data for the movement of the robotic arm.

If each single axis joint of the plurality of robotic arm sections comprises a motorized swivel and a single axis control system for controlling rotational speed and direction of the motorized swivel in accordance with received instructional data and if the multiple axis joint of the gripping tool comprises a plurality of motorized swivels) and a multiple axis control system for controlling rotational speed and direction of each motorized swivel in accordance with received instructional data, the at least one processing module may preferably be configured to transmit via a transmitter processed data to control operations of at least one of the motorized swivels.

In another preferred example, the gripping tool further comprise a gripping shaft/link and an attachment device rotationally fixed to the gripping shaft via a motorized single axis joint having a single rotational axis. Note that the gripping shaft or link may be any part linking the attachment device rotationally with the outermost section.

Moreover, the attachment device may be any type that allows releasable gripping of an object such as a claw, a magnet, etc.

The motorized single axis joint may be located anywhere on the gripping tool as long as the configuration provides the desired rotation of the attachment device.

In a second aspect, the invention concerns a vessel comprising a robotic arm in accordance with any of the above-mentioned features and a deck onto which the first longitudinal end of the first robotic arm section is rotatably fixed.

The vessel may also comprise a vessel sensoring means arranged with an offset from the robotic arm. Such a vessel sensoring means may be configured to detect an object located within a distance Dᵥₛ from a reference point on the vessel, for example on the vessel sensoring means itself. The distance Dᵥₛ may be equal or near equal to the distance Dᵣₛ described above for the robotic arm sensoring means.

The detected object may be a stationary object on the vessel, on a quay, offshore facilities, specific parts of a larger assembly such as a mooring system, etc. It may alternatively, or in addition, be a moving object such as an approaching vessel, a human being on the deck, the operation of one or more robotic arms, vehicles on deck, etc.

The vessel sensoring means may determine the distance from the reference point to the detected object, the size of the detected object, for example the cross-sectional area perpendicular to the line of sight of the vessel sensoring means and at least one physical property of the detected object, for example temperature, colour, radioactivity, chemical compositions, etc.

As for the robotic arm sensoring means, examples of the vessel arm sensoring means may be 2D camera(s), 3D camera(s), radar(s), laser(s), ultrasonic sensor(s), ultraviolet sensor(s) and/or infrared sensor(s). As described above, a LIDAR sensor is an example of a sensor utilizing one or more of the latter three.

In one example the inventive vessel may further comprise a security module comprising the vessel arm sensoring means, the robotic arm sensoring means, a computer/processing means and a computer-readable data carrier having stored thereon a computer program comprising instructions which, when the program is executed by the computer, cause the computer to carry out the following steps in sequence:
a) check whether the robotic arm sensoring means or the vessel sensoring means has detected an object,
b) if yes, determine the distance from a reference point on the vessel to the detected object, the size of the detected object and/or at least one physical property of the detected object,
c) check whether the robotic arm sensoring means or the vessel sensoring means other than the robotic arm sensoring means or the vessel sensoring means in step a) has detected an object,
d) if yes, determine the same object parameter(s) as in step b) relative to a common reference point, and
e) determine whether the value of the object parameter(s) in step d) is/are equal or near equal to the object parameter(s) of step b).

In another example the inventive vessel may further comprise a dedicated vessel positioning means configured to register/measure at least one positioning parameter of a detected object, for example by using earth fixed GPS and/or D-GPS, and arranged a distance from the robotic arm.

The positioning parameters may be position relative to the vessel positioning means, velocity relative to the vessel positioning means, velocity change within a predefined time period such as within 1 second, position change within a predefined time period such as within 1 second and/or directional change within a predefined time period such as within 1 second.

It is considered advantageous that the sensoring means and the registration means constitute a single unit as the case is for a LIDAR sensor.

As for the robotic arm, the inventive vessel may further comprise a global positioning sensor such as earth fixed GPS/D-GPS and/or a local positioning sensor such as a gyroscope/motion reference unit (see description above) arranged a distance from the robotic arm.

In a third aspect, the invention concerns a method for automatically displacing an object between two locations using a robotic arm on a vessel in accordance with any of the features described above.

The method comprises the following steps:
A. manoeuvring the outermost longitudinal section by operating one or more motorized joints/swivels located between the deck and the outermost longitudinal section to a first position where the gripper tool is arranged adjacent or near adjacent to the object to be displaced,
B. releasably attaching the gripper tool to the object, preferably by use of a dedicated attachment device such as a magnet, a claw or a hook,
C. manoeuvring the outermost longitudinal section with the object by operating one or more motorized joints/swivels located between the deck and the outermost longitudinal section to a second position where the object is to be arranged.

At least one of the steps A-C may be activated and/or controlled based on positional data collected by a robotic arm sensoring means and/or a robotic arm positioning means arranged on the outermost section and/or the gripping tool.

One or both of steps A and C may further comprise the step of checking at a predetermined frequency, for example each 0.1 second, whether an object is obstructing the manoeuvring path by analysing output data from the robotic arm sensoring means and/or the robotic arm positioning means arranged on the outermost section and/or the gripping tool.

If the vessel comprises a security module as described above, each of step a) to e) may be executed during step A and/or step B and/or step C.

In a fourth aspect the invention concerns a data processing apparatus comprising a processor configured to perform the steps A-C in accordance with any features of the above described method.

In a preferred example, the data processing apparatus is fixed to the robotic arm.

In a fifth aspect the invention concerns a use of a robotic arm according to any of the features described above for performing one or more of the following operations:
washing of a fish cage by using the gripping tool as a washing device,
transporting one or more objects between a fish carrier onto which the robotic arm is rotationally fixed and a fish cage,
transporting a rope eye attached to a mooring rope from a position on a floating vessel onto which the robotic arm is fixed to a bollard on a quay,
transporting a rope eye attached to a mooring rope from a position on a quay onto which the robotic arm is fixed to a position on a floating vessel,
transporting a rope eye attached to a mooring rope from a position on a deck of a floating vessel onto which the robotic arm is fixed to a bollard on a hull of the floating vessel,
transporting one or more objects between a service operation vessel onto which the robotic arm is fixed and a stationary offshore installation such as a wind mill,
transporting one or more objects between a service operation vessel and a stationary offshore installation onto which the robotic arm is fixed and
transporting objects between two floating vessels, where the robotic arm is rotationally fixed to one of the two floating vessels.

If the robotic arm is fixed on a floating structure such as a vessel, it may be advantageous to configure the robotic arm such that it is heave compensated relative to the movements of the vessel.

For the first mentioned use, the gripping tool may itself act as a washing device. Alternatively, or in addition, the gripping tool may hold a dedicated washing device during washing.

The inventive robotic arm as described above covers a multiaxial robotic arm capable of reaching all possible positions within a set maximum circumference and from all possible angles.

If such a versatile configuration is required, a robotic arm being able to manoeuvre in space in at least six degrees of freedom is needed. Such a six degrees of freedom manoeuvrability or more would, under the condition that there is enough space for the robotic arm to operate into and that there are no obstacles to avoid, normally be sufficient to reach all positions within the set maximum range.

More than six degrees of freedom is feasible. For instance, by assembling a robotic arm with a number of robotic arm sections corresponding to seven degrees of freedom, a more dexterous robot motions, positioning and path planning is achieved. A robotic arm is termed cinematically redundant when it possesses more degrees of freedom than is needed to execute a given task.

On the other hand, this requires another set of equations matrixes to control the positions of the links/sections. The numbers of possible solutions will normally be infinite when there are more than six axes in a robotic arm. To handle the infinity problem certain techniques have been established to punish bad solutions and award good solutions.

This fact may turn out to be of importance when there is a need for compensation for heave, roll, and pitch movements and regulate towards catching an object precisely in a narrow environment with obstacles to come around.

### BRIEF DESCRIPTION OF THE DRAWINGS

FIG. 1 illustrates in perspective an inventive robotic arm.

FIG. 2 illustrates schematically the rotational axes and the joints of the robotic arm of FIG. 1.

FIG. 3 illustrates in perspective details of a gripping tool attached via motorized swivels to an end of an inventive robotic arm.

FIG. 4 illustrates in perspective an example of a motorized single axis joint.

FIG. 5 illustrates in perspective a mooring system using the robotic arm of FIGS. 1 and 2, where a gripping tool at the end of the robotic arm is mooring a rope eye to a bollard on a quay.

FIG. 6 illustrates in perspective a mooring system using the robotic arm of FIGS. 1 and 2, where a gripping tool at the end of the robotic arm is mooring a rope eye to a bollard on the vessel's exterior hull.

FIG. 7 illustrates in perspective details of a gripping tool attached via motorized swivels to an end of an inventive robotic arm, where an attachment device constituting part of the gripping tool is holding a sheave fixed to a rope eye during mooring of the rope eye to a bollard.

FIG. 8 illustrates in perspective details of a gripping tool attached via motorized swivels to an end of an inventive robotic arm, where an attachment device constituting part of the gripping tool is approaching a sheave fixed to a rope eye.

FIGS. 9 (A) and (B) illustrate in perspective an inventive robotic arm fixed to a deck of a vessel's bow part and aft part, respectively.

### DETAILED DESCRIPTION OF THE INVENTION

In the following, specific embodiments of the invention will be described in more detail with reference to the drawings. However, the invention is not limited to the embodiments and illustrations contained herein. It is specifically intended that the invention includes modified forms of the embodiments, including portions of the embodiments and combinations of elements of different embodiments. It should be appreciated that in the development of any actual implementation, as in any engineering or design project, specific decisions must be made to achieve the developer's specific goals, such as compliance with system and/or business related constraints. Moreover, it should be appreciated that such a development effort might be complex and time consuming, but would nevertheless be a routine undertaking of design, fabrication and manufacture for the skilled person having the benefit of this disclosure.

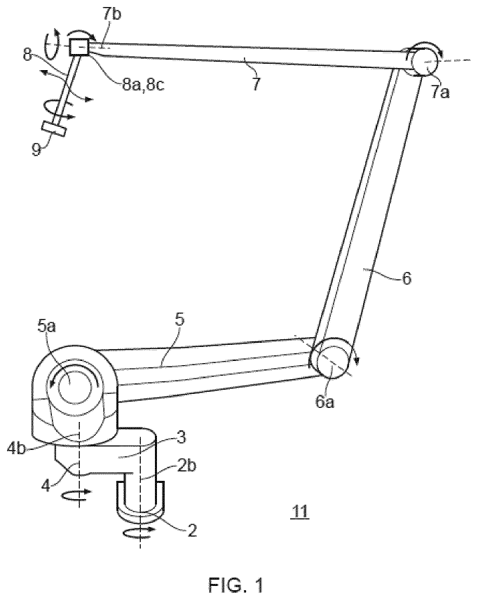

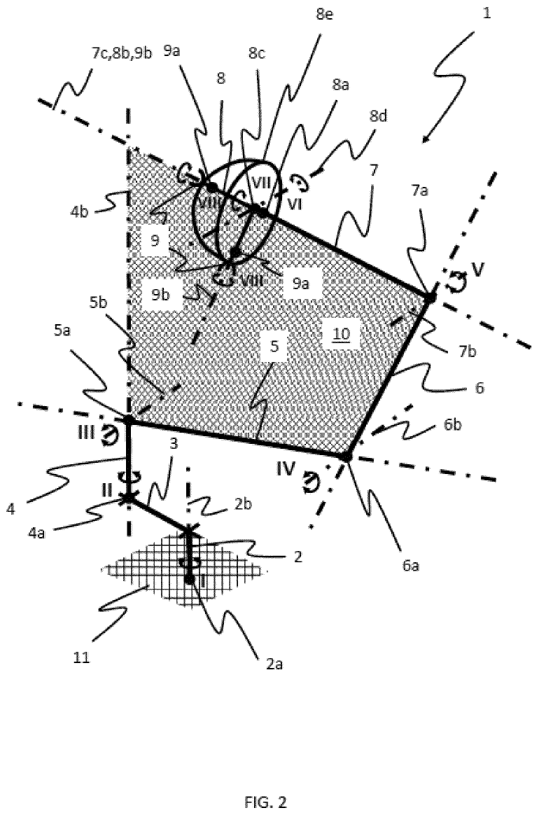

A specific embodiment of a robotic arm 1 in accordance with the invention is shown in FIGS. 1 and 2. A longitudinal end of a first robotic arm section 2 is rotationally coupled perpendicular to the deck 11, thus creating an upwards directed rotational axis 2a. A longitudinal end of a second robotic arm section 3 is fixed perpendicular to the other longitudinal end of the first robotic arm section 1, thereby forming a pivotable structure 2,3 which inter alia contributes to the robotic arms ability to avoid the above-mentioned obstruction elements 23.

Further, a third robotic arm section 4 is rotationally fixed to the other end of the second robotic arm section 3 with a rotational axis 4b oriented parallel to the upward direction rotational axis 2b of the first robotic arm section 2.

The first to third sections 2-4 thus form a pivotable base of the robotic arm 1 that may rotate relative to the deck 11 with an offset set by the length of the second section 3.

The rotational connections of both the first section 2 to the deck 11 and the third section 4 to the second section 3 are achieved by use of motorized joints 2a,4a such as motorized swivels 2a,4a equipped with a control system allowing automatic control of the swivels rotational direction and rotational velocity. The joints 2a,4a are preferably single axis joints, that is, joints that allows movement around one rotational axis only.

FIGS. 1 and 2 further show that the third section 4 is rotationally coupled to a set of robotic arm sections 5-7 mutually interlinked in an end-to-end fashion. Specifically, an end of an innermost longitudinal section 5 of the set is rotationally coupled via a motorized single axis joint 5a to the third section and rotationally coupled via a motorized single axis joint 6a at the other end to an end of an intermediate longitudinal section 6. Further, the other end of the intermediate section 6 is rotationally coupled via a motorized single axis joint 7a to an end of an outermost longitudinal section 7.

Additional intermediate longitudinal sections may be added in a similar end-to-end fashion between the innermost and outermost longitudinal sections if higher axes robotic arm is desired/needed.

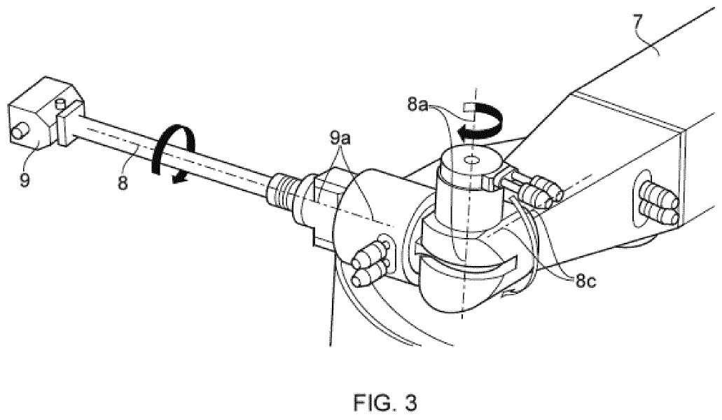

With particular reference to FIG. 2, the direct consequence that all of the rotational axes 5b-7b involved for the set of interlinked robotic arm sections are aligned 5-7 causes the longitudinal direction 7c of the outermost section 7 to coincide with the rotational axes 4b of the third robotic arm section 4. If corrected for any offset between the ends of the intercoupling robotic arm sections (see FIG. 3), the rotational axis 4b of the third robotic arm section 4 and the longitudinal directions of the innermost, intermediate and outermost sections 5-7 creates the boundary of a common rotational plane 10 for set of robotic arm sections 5-7.

As seen in FIGS. 1 and 2, and further detailed in FIG. 3, a gripping tool 8,9 comprising a gripping shaft or link 8 and an attachment device 9 is rotationally coupled to the other end of the outermost longitudinal section 7 via one or more motorized joints 8a,8c. In the embodiment of FIG. 3 the attachment device 9 is a magnet. However, it may be any device enabling releasable attachment to an object. Other examples may be a claw or a hook.

In contrast to the joints within the set of robotic arm sections 5-7 and to the third section, the motorized joint 8a,8c between the gripping shaft or link 9 and the end of the outermost section 7 preferably includes a multiple number of swivels 8a,8c that allows the gripping shaft 8 to rotate around deviating rotational axes 8b,8d. FIGS. 1-3 illustrate the most preferred embodiment where the joints 8a,8c includes two motorized swivels configured to allow rotation of the gripping shaft 8 around two rotational axes directed perpendicular to each other. The resulting superimposed rotation pattern would thus follow spherical coordinates/sphere 8e. If desired, the gripping shaft 8 may be made length adjustable, for example by making the gripping shaft 8 telescopic.

The coupling between the attachment device 9 and at the other end of the gripping shaft 8 is preferably also made rotational by use of a motorized single axis joint 9a, thereby allowing the attachment device 9 to rotate around a rotational axis 9b. The joint 9a may be placed anywhere on the gripper tool 8,9 as long as it results in a rotation of the attachment device 9 that may be operated independently of the operation of the joints 8a and 8c. In the example of FIG. 3, the motorized single axis joint 9a is arranged adjacent to the motorized joint 8a,8c.

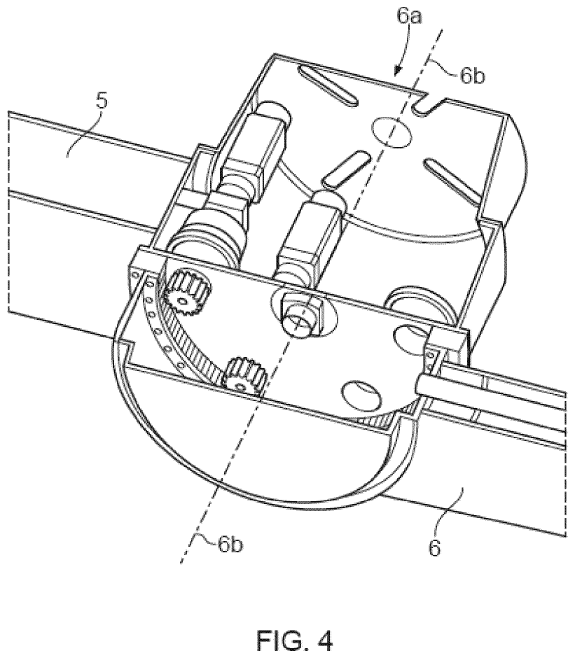

As an example of a motorized single axis joint, a rotational coupling between the innermost longitudinal section 5 and the intermediate longitudinal section 6 is shown in FIG. 4. For this particular swivel arrangement 6a, the sections 5,6 are relatively displaced along the rotational axis 6b. The controlled rotation is achieved by use of a system comprising cog wheels coupled to suitable motors such as programmable stepper motors.

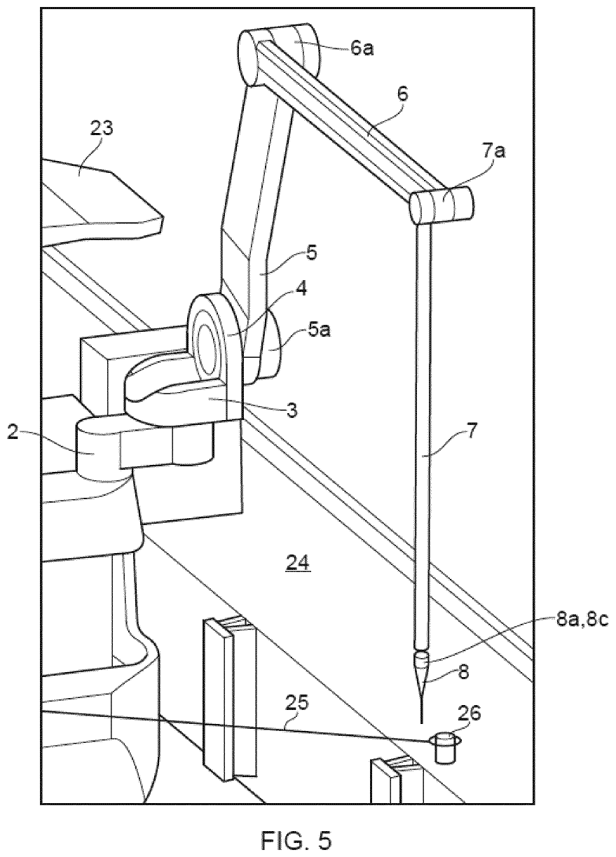

FIG. 5 shows an example of use of the inventive robotic arm 1 described above; mooring a vessel 20 to a quay 24. The first robotic arm section 2 is rotationally fixed to a deck 11 or a hull 12 of the vessel 20 in a position where the attachment device 9 is within reach of the position of a rope eye 25a of a mooring line 25.

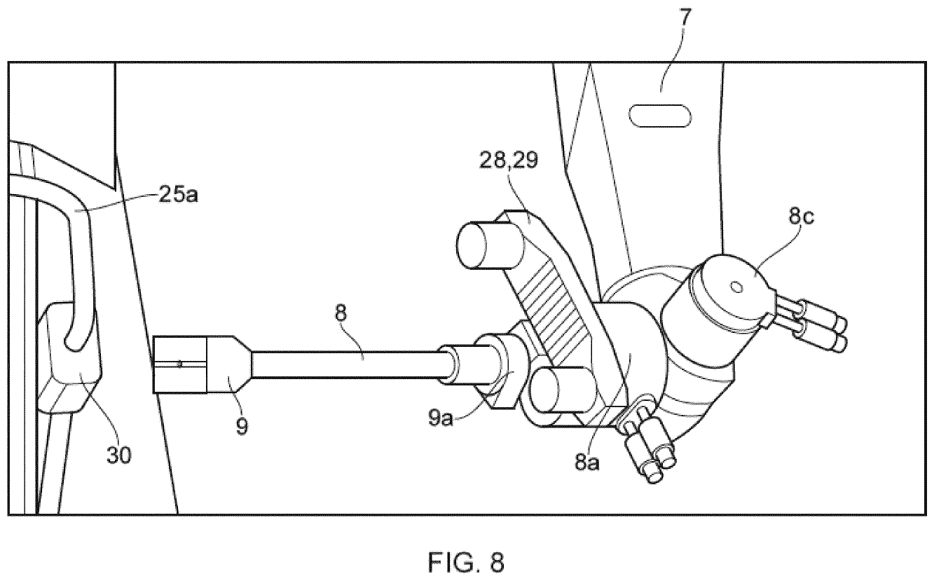

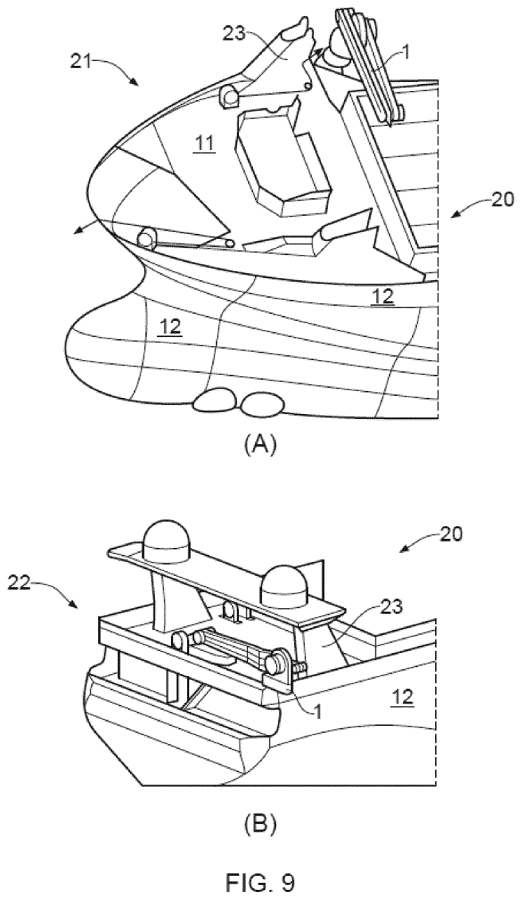

The mooring procedure of the vessel 20 to the quay 24 may proceed as follows:
The motorized joints 2a,4a-7a of the robotic arm 1 is operated to move the outermost section 7 with the attached gripper tool 8,9 at its end from a folded, parked position to a position where the attachment device 9 of the gripper tool 8,9 is located adjacent to the rope eye 25a. Image and/or position generating sensors 28,29 (see FIG. 8), hereinafter referred to as the sensor system 28,29, may be used to detect e.g. deck structures 23 (see FIG. 9) not registered in an available database and/or to verify correct entry in such database, thereby allowing the robotic arm 1 to make necessary movements to avoid undesired impacts. The sensor system 28,29 may also be used to locate the exact location of the rope eye 25a or any gripping structure 30 adjacent or on the rope eye 25a. The sensory system 28,29 may for example contain one or more of a 2D camera, a 3D camera, a radar, a laser, an ultrasonic sensor, an ultraviolet sensor and an infrared sensor. A specific example can be the use of a LIDAR.
If needed, one or more of the motorized joints 8a,8c,9a are operated to perform further adjustment of the position of the attachment device 9 relative to the rope eye 25a or gripping structure 30 to ensure that the attachment device 9 is close enough, and in a favourable orientation, to allow releasable coupling with the rope eye 25a/gripping structure 30.
The releasable coupling is established, for example by activating an electromagnet or operating a claw.
The motorized joints 2a,4a-7a of the robotic arm 1 is operated to transport the rope eye 25a and the attached mooring line 25 to a position adjacent a bollard 26 on the quay 24. As for the first step, the sensor system 28,29 may be used to detect the position and the size of the bollard 26 to enable mooring and/or to detect the positions and the sizes of other type of obstacles such that the robotic arm 1 may make necessary adjustments to avoid undesired impacts.
One or more of the motorized joints 2a,4a-7a of the robotic arm sections 2-7 and/or one or more of the motorized joints 8a,8c,9a of the gripping tool 8,9 are operated to guide the rope eye 25a around the bollard 26. For example, the mutual operation of the motorized joints 2a,4a-7a, 8a,8c,9a may first align the rope eye 25a until the opening is facing the side of the bollard 26, then guide the rope eye 25a around the bollard 26 by translational and/or rotational movement towards the bollard 26.
The coupling between the attachment device 9 and the rope eye 25a or gripping structure 30 is released, for example by sending a signal to the electromagnet or by opening the claw.
The motorized joints 2a,4a-7a is operated to move the robotic arm 1 back to its parked, folded position on the deck 11.

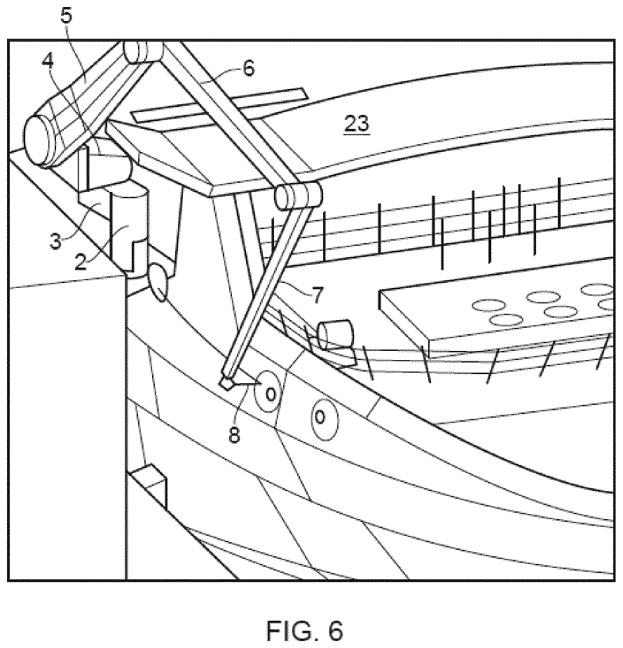

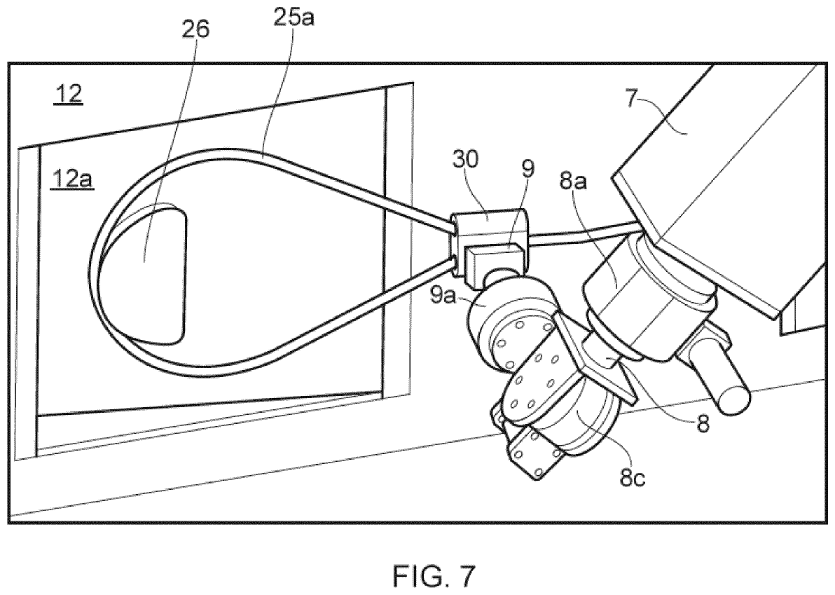

FIGS. 6-8 show another example of use of the inventive robotic arm 1 described above; parking or removing a rope eye 25a to/from a dedicated bollard 26 fixed in a recess 12a of a vessel's 20 exterior hull 12.

As for the example in FIG. 5, the first robotic arm section 2 is rotationally fixed to a deck 11 or a hull 12 of the vessel 20 in a position where the attachment device 9 is within reach of the position of a rope eye 25a of a mooring line 25, for example within reach of a rope eye 25a moored to a bollard 26 on a quay 24.

The parking procedure may proceed in a similar manner as for the above described procedure for mooring a mooring line 25 to a quay 24 (FIG. 5).

Other examples of use of the robotic arm 1 may be
washing of a fish cage by using the attachment device 9 as a washing device,
transporting objects 30 between a fish carrier onto which the robotic arm 1 is fixed and a fish cage,
transporting objects 30 between a service operation vessel onto which the robotic arm 1 is fixed and a stationary offshore installation,
transporting objects 30 between a service operation vessel and a stationary offshore installation onto which the robotic arm 1 is fixed and
transporting objects 30 between two floating vessels 20, where the robotic arm 1 is fixed to one of the two floating vessels 20.

FIGS. 9A and 9B show a robotic arm 1 installed on a deck 11 of a vessel 20 at vessel's bow 21 and the vessel's aft 22, respectively. The remaining parts of the deck 11 is seen to contain numerous deck structures 23 that may act as potential obstruction elements during operation of the robotic arm 1. Such deck structures 23 include both fixed structures such as the deck infrastructure and removable objects such as containers, personnel, etc. It is thus considered advantageous that robotic arms such as the inventive robotic arm 1 have a high degree of manoeuvrability to minimize the risk of undesired impacts. This is of particular importance when aiming for autonomous or near autonomous operation since there is little or no possibility of manual interference.

It is appreciated that certain features of the invention, which, for clarity, have been described above in the context of separate embodiments, may also be provided in combination in a single embodiment. Conversely, various features of the invention, which, for brevity, have been described in the context of a single embodiment, may also be provided separately or in any suitable sub-combination.

### LIST OF REFERENCE NUMERALS/LETTERS

| | |
|---|---|
| 1 | Robotic arm |
| 2 | First robotic arm section |
| 2a | Motorized joint (between first robotic arm section and deck) |
| 2b | Rotational axis of first robotic arm section |
| 3 | Second robotic arm section |
| 4 | Third robotic arm section |
| 4a | Motorized joint (between second and third arm sections) |
| 4b | Rotational axis of third robotic arm section |
| 5 | Innermost longitudinal section (of plurality of robotic |
| | arm sections) |
| 5a | Motorized single axis joint (between third robotic arm |
| | section and innermost section) |
| 5b | Single rotational axis of innermost section |
| 6 | Intermediate longitudinal section (of plurality of robotic |
| | arm sections) |
| 6a | Motorized single axis joint (between innermost and |
| | intermediate sections) |
| 6b | Single rotational axis of intermediate section |
| 7 | Outermost longitudinal section (of plurality of robotic |
| | arm sections) |
| 7a | Motorized single axis joint (between intermediate and |
| | outermost sections) |
| 7b | Single rotational axis of outermost longitudinal section |
| 7c | Longitudinal direction of outermost longitudinal section |
| 8 | Gripping shaft/link (of gripping tool) |
| 8a | Motorized single axis joint (of motorized multiple axis joint) |
| 8b | First single rotational axis of gripping shaft/link (of multiple |
| | rotational axes) |
| 8c | First motorized single axis joint (of motorized multiple |
| | axis joint) |
| 8d | Second single rotational axis of gripping shaft/link (of |
| | multiple rotational axes) |
| 8e | Spherical coordinates in space, sphere showing rotational |
| | restriction of gripping shaft/link |
| 9 | Attachment device (of gripping tool)/magnet/claw/hook |
| 9a | Motorized joint (of attachment device) |
| 9a | Rotational axis of attachment device (and possibly also |
| | gripping shaft/link) |
| 10 | Common rotational plane for plurality of robotic arm sections |
| 11 | Deck (of vessel 20) |
| 12 | Hull (of vessel 20) |
| 12a | Recess in hull |
| 20 | Vessel |
| 21 | Bow portion (of vessel 20) |
| 22 | Aft portion (of vessel 20) |
| 23 | Infrastructure (on deck 11) |
| 24 | Quay |
| 25 | Mooring rope |
| 25a | Rope eye |
| 26 | Bollard |
| 28 | Image generating sensors/robotic arm sensoring means |
| 29 | Position generating sensors/robotic arm positioning means |
| 30 | Object to be transferred/sheave |
| I | First rotation joint (between deck and first robotic arm section) |
| II | Second rotation joint (between second and third robotic |
| | arm section) |
| III | Third rotation joint (between third robotic arm section and |
| | innermost section) |
| IV | Fourth rotation joint (between innermost and intermediate |
| | section) |
| V | Fifth rotation joint (between intermediate and outermost |
| | section) |
| VI | Sixth rotation joint (between outermost section and |
| | gripping shaft/link) |
| VII | Seventh rotation joint (between gripping shaft/link and |
| | attachment device) |
| VIII | Eighth rotation joint |

1. A robotic arm for automatically displacing an object between two locations based on a combination of pre-set instructional data and dynamically updated instructional data, comprising:
a first robotic arm section having a first longitudinal end configured to be coupled to a support structure,
a third robotic arm section rotatably coupled at least indirectly to the first robotic arm section,
a plurality of robotic arm sections, wherein each of the plurality of robotic arm sections are rotatably coupled via motorized single axis joints with respective single rotational axes, the plurality of robotic arm sections comprising an innermost longitudinal section rotatably coupled to the third robotic arm section via a motorized single axis joint with a respective rotational axis, an outermost longitudinal section and an intermediate longitudinal section rotationally fixed to the innermost longitudinal section via a single axis joint with a respective single rotational axis and to the outermost longitudinal section via a single axis joint with a respective rotational axis and
a gripping tool rotatably coupled to a longitudinal end of an outermost longitudinal section of the plurality of robotic arm sections via a motorized multiple axis joint with respective multiple rotational axes, wherein the rotational couplings within the plurality of robotic arm sections and to the third robotic arm section are configured such that a longitudinal direction of the outermost longitudinal section intersects a rotational axis of the third robotic arm section,
a robotic arm sensoring means for detecting objects located within a distance Dᵣₛ from a reference point on the robotic arm and,
the robotic arm sensoring means is configured to determine, based on receiving signals from the detected object,
the distance to the detected object,
the size of the detected object, and
at least one physical property of the detected object.

2. The robotic arm in accordance with claim 1, wherein the rotational couplings within the plurality of robotic arm sections and to the third robotic arm section are configured such all single rotational axes of the plurality of robotic arm sections are oriented parallel to each other.

3. The robotic arm in accordance with claim 1, wherein the robotic arm further comprises:
a second robotic arm section fixed with a non-zero angle to the first robotic arm section relative to the longitudinal direction of the first and second robotic arm sections and wherein
the third robotic arm section is rotationally fixed to the second robotic arm section via a motorized joint.

4. The robotic arm in accordance with claim 1, wherein the multiple axis joint is configured to allow simultaneous rotation of the gripping tool around a first rotational axis and around a second rotational axis directed perpendicular to the first rotational axis, wherein the simultaneous rotation of the gripping tool around the first and second rotational axis is restricted to spherical coordinates in space.

5. The robotic arm in accordance with claim 1, wherein each single axis joint of the plurality of robotic arm sections comprises:
a motorized swivel and
a single axis control system for controlling rotational speed and direction of the motorized swivel in accordance with received instructional data.

6. The robotic arm in accordance with claim 1, wherein the multiple axis joint of the gripping tool comprises:
a plurality of motorized swivels, and
a multiple axis control system for controlling rotational speed and direction of each motorized swivel in accordance with received instructional data.

7. The robotic arm in accordance with claim 1, wherein the robotic arm sensoring means is arranged on at least one of the outermost longitudinal section and the gripping tool.

8. The robotic arm in accordance with claim 1, wherein the robotic arm sensoring means comprises at least one of:
2D camera,
3D camera,
radar,
laser,
ultrasonic sensor,
ultraviolet sensor and
infrared sensor.

9. The robotic arm in accordance with claim 1, wherein the robotic arm comprises a control system comprising a plurality of modules,
wherein at least one pre-processing module of the plurality of modules is configured to receive data generated by at least one sensoring means or at least one positioning means or a combination thereof and to select a data subset of the received data for further data processing, and
wherein at least one processing module of the plurality of modules is configured to receive the data subset from the at least one pre-processing module and to use the data subset as input data in a computer program stored on a computer-readable data carrier in the at least one processing module,
wherein the computer program comprises instructions which, when the program is executed by the at least one processing module, cause the computer program to provide as output instructional data for the movement of the robotic arm.

10. The robotic arm in accordance with claim 9, wherein each single axis joint of the plurality of robotic arm sections comprises:
a motorized swivel, and
a single axis control system for controlling rotational speed and direction of the motorized swivel in accordance with received instructional data, and
the multiple axis joint of the gripping tool comprises:
a plurality of motorized swivels, and
a multiple axis control system for controlling rotational speed and direction of each motorized swivel in accordance with received instructional data,
wherein the at least one processing module is further configured to transmit via a transmitter processed data to control operations of at least one of the motorized swivels.

11. The robotic arm in accordance with claim 1, wherein the gripping tool further comprises:
a gripping shaft, and
an attachment device rotationally fixed to the gripping shaft via a motorized single axis joint.

12. A vessel comprising:
a robotic arm in accordance with claim 1, and
a deck onto which the first longitudinal end of the first robotic arm section is rotatably fixed.

13. A method for automatically displacing an object between two locations using a robotic arm on a vessel in accordance with claim 12, wherein the method comprises the following steps:
A. manoeuvring the outermost longitudinal section by operating at least one motorized swivel located between the deck and the outermost longitudinal section to a first position where the gripper tool is arranged adjacent to the object to be displaced,
B. releasably attaching the gripper tool to the object,
C. manoeuvring the outermost longitudinal section with the object by operating the at least one motorized joints/swivels located between the deck and the outermost longitudinal section to a second position where the object is to be arranged,
wherein at least one of the steps are activated and/or controlled based on positional data collected by a robotic arm sensoring means arranged on at least one of the outermost longitudinal section and the gripping tool.

14. The method in accordance with claim 13, wherein at least one of step A and C further comprises:
checking at a predetermined frequency whether an object is obstructing the manoeuvring path by analysing output data from the robotic arm sensoring means arranged on at least one of the outermost section and the gripping tool.

15. A data processing apparatus comprising a processor configured to perform the steps A-C of claim 13.

16. Use of a robotic arm according to claim 1 for performing at least one of the following operations:
washing of a fish cage by using the gripping tool as a washing device,
transporting a rope eye attached to a mooring rope from a position on a floating vessel onto which the robotic arm is fixed to a bollard on a quay,
transporting a rope eye attached to a mooring rope from a position on a quay onto which the robotic arm is fixed to a position on a floating vessel,
transporting a rope eye attached to a mooring rope from a position on a deck of a floating vessel onto which the robotic arm is fixed to a bollard on a hull of the floating vessel,
transporting objects between a fish carrier onto which the robotic arm is fixed and a fish cage,
transporting objects between a service operation vessel onto which the robotic arm is fixed and a stationary offshore installation,
transporting objects between a service operation vessel and a stationary offshore installation onto which the robotic arm is fixed, and
transporting objects between two floating vessels, where the robotic arm is fixed to one of the two floating vessels.

17. The robotic arm in accordance with claim 1, wherein the first longitudinal end of the first robotic arm section is configured to be rotatably coupled to the support structure via a motorized joint.

18. The robotic arm in accordance with claim 17, wherein the rotational couplings within the plurality of robotic arm sections and to the third robotic arm section are configured such all single rotational axes of the plurality of robotic arm sections are oriented parallel to each other.

19. The robotic arm in accordance with claim 17, wherein the robotic arm further comprises:
a second robotic arm section fixed with a non-zero angle to the first robotic arm section relative to the longitudinal direction of the first and second robotic arm sections and wherein
the third robotic arm section (4) is rotationally fixed to the second robotic arm section via a motorized joint.

20. The robotic arm in accordance with claim 17, wherein the multiple axis joint is configured to allow simultaneous rotation of the gripping tool around a first rotational axis and around a second rotational axis directed perpendicular to the first rotational axis, wherein the simultaneous rotation of the gripping tool around the first and second rotational axis is restricted to spherical coordinates in space.
